(19) United States
(12) Patent Application Publication
(10) Pub. No.: US 2002/0171530 A1
(43) Pub. Date: Nov. 21, 2002

(54) Production method of thin film passive element formed on printed circuit board and thin film passive element produced by the method

(75) Inventors: Motoshi Shindoh, Fujisawa-shi (JP); Shigeru Michiwaki, Yokohama-shi (JP); Koichi Kamiyama, Tokyo (JP); Hisanori Yoshimizu, Yokosuka-shi (JP)

Correspondence Address: ANDERSON KILL & OLICK, P.C., 1251 Avenue of the Americas, New York, NY, 10020, US

(73) Assignee: VICTOR COMPANY OF JAPAN, LIMITED

(21) Appl. No.: 10/113,621

(22) Filed: Mar. 28, 2002

Related U.S. Application Data
(63) Continuation-in-part of application No. 09/794,596, filed on Feb. 27, 2001, now Pat. No. 6,411,194.

(30) Foreign Application Priority Data
Mar. 30, 2000 (JP) 2000-095497
Mar. 30, 2001 (JP) 2001-102412

(51) Int. Cl. H01F 5/00

(52) U.S. Cl. 336/200

(57) ABSTRACT

The present invention provides a thin film capacitance element having minimal deviation of capacitance value in a high accuracy formed on a printed circuit board (core material). The thin film capacitance element formed on a printed circuit board is composed of a lower electrode layer formed on the printed circuit board through an insulation layer, a dielectric layer formed on the lower electrode layer, an upper electrode layer formed on the dielectric layer and an electric pad for leading out the lower electrode layer, wherein the lower electrode layer is longer than the upper electrode layer in the horizontal direction and connected to the electric pad for leading out the lower electrode layer outside, and wherein the top surface of the upper electrode layer and the top surface of the electric pad for leading out the lower electrode layer are formed substantially in the same height.

### RELATED APPLICATIONS

This application is a continuation-in-part (CIP) of U.S. patent application Ser. No. 09/794,596, entitled “PRODUCTION METHOD OF THIN FILM RESISTANCE ELEMENT FORMED ON PRINTED CIRCUIT BOARD, AND THIN FILM RESISTANCE ELEMENT EMPLOYING THE METHOD”, filed Feb. 27, 2001.

### BACKGROUND OF THE INVENTION

1. Field of the Invention

The present invention is related to a production method of a thin film passive element such as a resistor, capacitor and coil formed on or buried in a printed circuit board, and the thin film passive element produced by the production method.

2. Description of the Related Arts

Generally, a printed circuited board used in various kinds of electronic apparatuses is further demanded to be reduced in size and weight, in particular, how to install electrically resistance bodies into the printed circuit board is a key not only to reduce the size and weight of the printed circuit board but also to maintain an accuracy value of resistivity of the resistance bodies. As one of examples for forming these resistance bodies in the prior arts, there is one where a printed circuit pattern is formed on, for instance, a ceramic substrate (core) and the resistance bodies are formed by applying an electrical resistance paste on the printed circuit pattern by using a printing method. This printing method has been widely used ever since, and the resistance bodies formed on the printed circuit pattern are referred to as a printed resistance body.

FIGS. 19(a) and 19(b) are cross sectional views for explaining a production method of a resistance body by a printing method in the prior arts.

With referring to FIGS. 19(a) and 19(b), a description is given of the production method of the printed resistance body in the prior arts.

In FIGS. 19(a) and 19(b), a character 2 designates a ceramic substrate (core) with an insulating layer on the surface thereof or maintaining an electrically insulating state. As shown in FIG. 19(a), on the surface of the ceramic substrate 2, an electrically conductive paste of Ag—Pd or like is applied by, for instance, a screen printing method, resulting in a pair of electrically conductive pads (referred to as conductive pads) 4 and 4, which are separated at a certain distance to each other. Then, on the surface of the ceramic substrate 2, an electrical resistance paste is applied by the screen printing method, resulting a printed resistance body 6 between the pair of conductive pads 4 and 4, which are separated to each other at a predetermined distance L as shown in FIG. 19(b).

The value of resistivity of the printed resistance body 6 depends on the dimensions of the printed resistance body 6, i.e., a resistance length L, a resistance width W (not shown) and a thickness t of the printed resistance body 6. Since the value of resistivity of the printed resistance body 6 is varied according to the dimensions, there arise problems as follows.

First, upon applying the electrically conductive paste and the resistance paste on the ceramic substrate 2 by the screen printing method, a shift of printing and penetration of these pastes inevitably occur, resulting in a deviation of value of resistivity in the printed resistance body 6.

In particular, a thickness of the resistance paste printed on the ceramic substrate 2 varies largely because of a difficulty to control printing conditions such as a squeezing pressure, a squeezing angle and a viscosity of resistance paste, resulting in an increase of the deviation of value of resistivity in the printed resistance body 6.

The conductive pads 4 and 4 made of Cu (copper) give poor ohmic contact. This causes a generation of an excess value of resistivity at connecting portions of the conductive pads 4. This fact poses a difficulty to obtain a designed value of resistivity with the printed resistance body 6.

Generally speaking, the deviation of value of resistivity thereby is as large as about ±30%. This fact implies to require an additional adjustment process such as trimming for correcting the value of resistivity to a designed value at the final stage.

### SUMMARY OF THE INVENTION

Accordingly, it is a general object of the present invention to provide a thin film passive element formed on a printed circuit board (core material), and the thin film passive element produced by the same method, in which above disadvantages have been effectively eliminated.

More specific object of the present invention is to provide a production method of a thin film passive element formed on a printed circuit board, and the thin film passive element produced by the same method, wherein the thin film passive element can be formed in such a manner that the dimensions such as the thickness thereof are controlled in high accuracy.

In order to achieve the above object, the present invention provides, according to an aspect thereof, a thin film capacitance element formed on a printed circuit board, comprising a lower electrode layer on the printed circuit board through an insulation layer; a dielectric layer formed on the lower electrode layer; an upper electrode layer formed on the dielectric layer; and an electric pad for leading out the lower electrode layer, wherein the lower electrode layer is longer than the upper electrode layer in the horizontal direction and connected to the electric pad for leading out the lower electrode layer outside, and wherein the top surface of the upper electrode layer and the top surface of the electric pad for leading out the lower electrode layer are formed substantially in the same height.

According to another aspect of the present invention, there provided a production method of a thin film capacitance element formed on a printed circuit board, comprising the steps of: forming a lower electrode layer on the printed circuit board through an insulation layer by a dry process used in producing a semiconductor; forming a dielectric layer on the lower electrode layer by the dry process; and forming an upper electrode layer on the dielectric layer by the dry process.

According to a further aspect of the present invention, there provided an inductance element formed on a printed circuit board, comprising: an inductance body formed spirally on the printed circuit board through an insulation layer, wherein the spiral inductance body includes at least a part of a conductive layer spirally; and a pair of input and output terminals provided on both ends of the inductance body.

According to a furthermore aspect of the present invention, there provided a production method of an inductance element, comprising the steps of: forming an inductance body including at least a part of a conductive layer spirally on a printed circuit board through an insulation layer by a dry process used in producing a semiconductor; and forming a pair of input and output terminals provided on both ends of the inductance body.

Other object and further features of the present invention will be apparent from the following detailed description when read in conjunction with the accompanying drawings.

### BRIEF DESCRIPTION OF THE DRAWINGS

FIGS. 1(a) and 1(b) are perspective views for explaining a thin film resistance element according to a first embodiment of the present invention.

FIG. 2 is a perspective view for explaining a thin film resistance element according to a second embodiment of the present invention.

FIG. 3 is a sectional view for explaining a thin film resistance element according to a third embodiment of the present invention.

FIGS. 4(a) to 4(f) are sectional views for explaining a production method of the thin film resistance element of the present invention.

FIGS. 5(a) and 5(b) are sectional views for explaining a thin film resistance element according to a fourth embodiment of the present invention.

FIGS. 6(a) and 6(b) are sectional views for explaining a thin film resistance element having a hollow for radiating heat according to a fifth embodiment of the present invention.

FIGS. 7(a) and 7(b) are sectional views for explaining a thin film resistance element having a hollow for radiating heat according to a sixth embodiment of the present invention.

FIG. 8 is a sectional view for explaining a thin film resistance element having a heat sink according to a seventh embodiment of the present invention.

FIGS. 9(a) to 9(c) are sectional views for explaining a production method of a thin film resistance element according to a eighth embodiment of the present invention, wherein the thin film resistance element is electrically connected to a circuit pattern formed in an inner layer of a printed circuit board.

FIGS. 10(a) to 10(g) are sectional views for explaining a production method of a thin film capacitance element of the present invention.

FIGS. 11(a) to 11(f) are sectional views for explaining an additional production method of a thin film resistance element in succession to the processes for forming the thin film capacitance element shown in FIGS. 10(a) to 10(g).

FIG. 12 is a perspective view of the thin film capacitance element shown in FIG. 10(g).

FIG. 13 is a plan view of the thin film capacitance element shown in FIG. 12.

FIG. 14 is a graph showing a relation between a thickness of dielectric layer and an insulation resistance value of the thin film capacitance element shown in FIG. 12.

FIG. 15 is a graph showing a relation between a thickness of dielectric layer and a capacitance value of the thin film capacitance element shown in FIG. 12.

FIG. 16 is a plan view of an inductance element of the present invention.

FIG. 17 is a vertical sectional view of the inductance element taken substantially along line A-A of FIG. 16.

FIGS. 18(a) to 18(j) are sectional views for explaining another production method of a thin film capacitance element of the present invention.

FIGS. 19(a) and 19(b) are sectional views for explaining a production method of a resistance body by a printing method in the prior arts.

### DETAILED DESCRIPTION OF THE PREFERRED EMBODIMENTS

Reference will now be made in detail to preferred embodiments of a thin film resistance element or body (referred as thin film resistance element hereinafter) in the present invention, examples of which are illustrated in the accompanying drawings.

[First Embodiment]

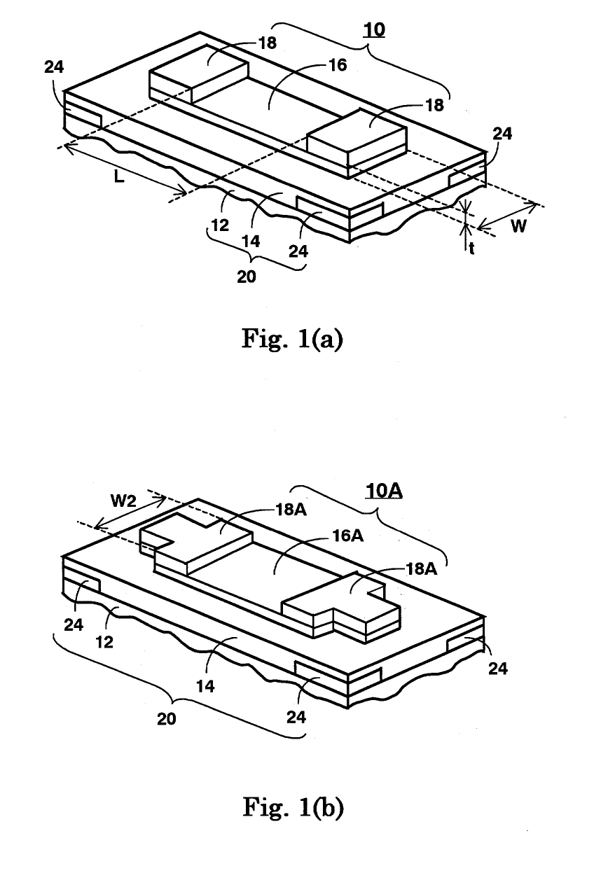

FIGS. 1(a) and 1(b) are perspective views for explaining a thin film resistance element according to a first embodiment of the present invention.

In the present invention, a thin film resistance element 10 is formed or buried by using a different method from the screen printing method in the prior arts.

In FIG. 1(a), a character 20 represents a printed circuit board (core material) comprising a core 12 or a substrate 12, for instance, made of resin, a thin copper plate 24 having a circuit pattern and an insulation layer 14.

As shown in FIG. 1(a), the thin film resistance element 10 of a first embodiment in the present invention is formed on the surface of the insulation layer 14 of the printed circuit board 20. In this case, the insulation layer 14 is formed on the printed circuit board (core material) 20. As another example, the insulation layer 14 may be formed on a top of a plurality of different type layers laminated on the printed circuit board (core material) 20, as mentioned hereinafter.

The above-mentioned thin film resistance element 10 formed on the insulation layer 14 is composed of a thin film resistance layer 16 having, for instance, a rectangular shape as a pattern and a pair of electrically conductive pads (referred to as conductive pads) 18 and 18 made of, for instance, copper, each formed on an distal end portion of the rectangular shape. The resistance value of the thin film resistance element 10 depends on a thickness “t” and dimensions of the pattern formed in the thin film resistance layer 16, actually, an width “W” of the thin film resistance layer 16 and a length “L” of the thin film resistance layer 16, which is defined by a distance between the pair of conductive pads 18 and 18 separating to each other.

The above-mentioned thin film resistance layer 16 is formed by the dry process, which is widely used for producing semiconductors. The dry process includes a sputtering method, an ion plating method, a vapor deposition method and a CVD (Chemical Vapor Deposition) method. The feature of the dry process for forming the thin film is to easily control a thickness of the thin film. Thereby, it is possible to obtain a thin film with a desired thickness in high accuracy compared with the screen printing method in the prior arts. Further, in the dry process, a photolithography method is used for forming a pattern in a thin film. The accuracy of the pattern obtained thereby is better than that by the screen printing method.

In order to form the pair of conductive pads 18 and 18, an electrically conductive layer (referred to as conductive layer) (not shown) is formed on the whole surface of the insulation layer 14 on which the thin film resistance layer 16 is formed. The conductive layer is selectively etched in such a manner that a part of the thin film resistance layer 16 is exposed so as to have a predetermined shape having a length “L” and a width “W”, remaining the pair of conductive pads 18 and 18. As well known, the resistance value of the thin film resistance element 10 is proportional to a product of the length “L” and the width “W” of the thin film resistance layer 16 as mentioned in the foregoing. Thereby, it is possible to obtain a desired resistance value of the thin film resistance element 16.

Accordingly, by the dry process method, the thin film resistance element 16 having higher accuracy than by the screen printing method can be obtained.

Further, a contact layer (not shown) may be provided on the insulation layer 14 made of resin, for instance, so as to enhance adhesion between the insulation layer 14 and the conductive layer made of Cu, for instance, for forming the conductive pads 18 and 18. In this case, the thin film resistance element 16 is formed on the contact layer before the conductive layer is formed.

Specifically, as the present applicant stated in the previous application (the Japanese Patent Application No. H11-95469/1999), it is difficult to cause the conductive layer to sufficiently contact with the insulation layer processed by a conventional surface treatment when a fine pattern is needed. Thus, the applicant proposed to provide the contact layer between the insulation layer and the conductive layer by using the dry process. In this embodiment, the thin film resistance layer 16 is formed on the contact layer (not shown) by using a patterning method. As the materials of the thin film resistance layer 16, many kinds of resistance materials such as Ni, Ni-Cr, and Ni-Cu are available.

In FIG. 1(a), there is illustrated a basic model of the thin film resistance element 10 in the first embodiment of the present invention, and in FIG. 1(b) a variation 10A of the thin film resistance element 10 is illustrated, wherein the shapes of conductive pads 18A and 18A and the thin film resistance layer 16A having a width “W2” are more complicated than those of the thin film resistance element 10 shown in FIG. 1(a). Specifically, the conductive pads 18 and 18 along with the end portions of the thin film resistance layer 16 shown in FIG. 1(a) have a rectangular shape but the conductive pads 18A and 18A along with the end portions of the thin film resistance layer 16A shown in FIG. 1(b) have a T-letter shape, respectively. This implies that according to the present invention, it is possible to form any shape of the thin film resistance element.

[Second Embodiment]

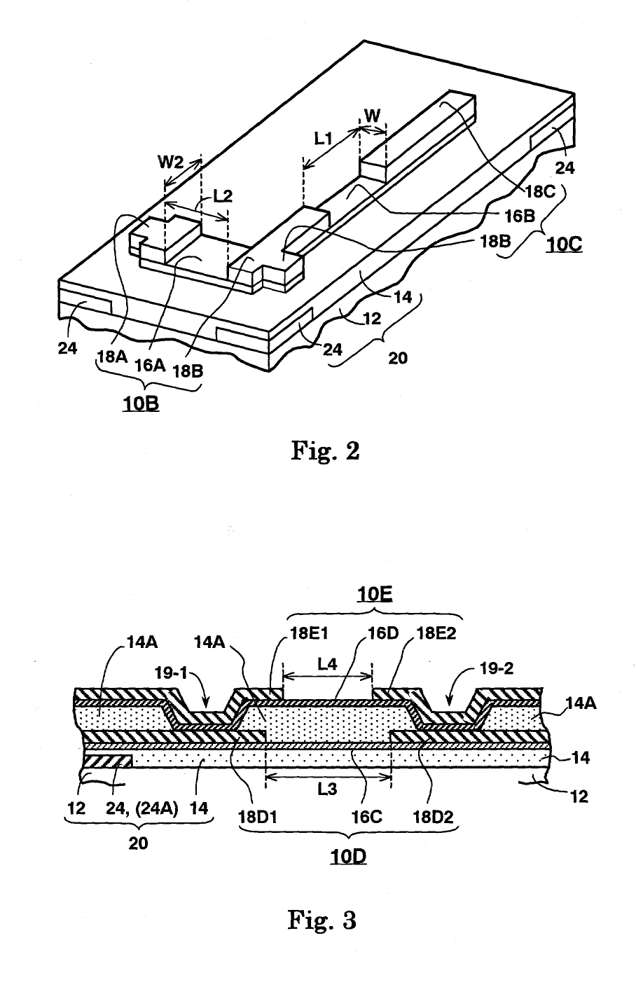

FIG. 2 is a perspective view for explaining a thin film resistance element according to a second embodiment of the present invention.

In FIG. 2, a thin film resistance element 10B is composed of conductive pads 18A and 18B and a thin film resistance layer 16A, and another thin film resistance element 10C is composed of conductive pads 18B and 18C and a thin film resistance layer 16B. The other configurations are the same as those of the first and second embodiment shown in FIGS. 1(a) and 1(b).

In the thin film resistance element 10B of the second embodiment shown in FIG. 2, the middle conductive pad 18B is commonly provided so as to electrically connect the thin film resistance element 10 shown in FIG. 1(a) and the thin film resistance element 10A shown in FIG. 1(b) in series, wherein the lengths of the thin film resistance elements 10B and 10C are made to be “L2” and “L1”, respectively, and the widths of the thin film resistance elements 10B and 10C are made to be “W2” and “W”, respectively.

[Third Embodiment]

FIG. 3 is a perspective view for explaining a thin film resistance element according to a third embodiment of the present invention.

Further, in a thin film resistance element 10E of the third embodiment shown in FIG. 3, the present invention is applied to a build-up printed circuit board (containing a build-up multi-layer printed circuit board).

In FIG. 3, a character 20 represents a printed circuit board (core material) comprising a core or substrate (resin) 12, a thin copper plate 24 having an inner circuit pattern 24A laminated on the substrate 12 and a lower insulation layer 14 covering the thin copper plate 24. In this embodiment, on the printed circuit board (core material) 20, a lower thin film resistance element 10D and an upper thin film resistance element 10E are stacked so that they are electrically connected in parallel.

Specifically, in the same manner as mentioned in FIGS. 1(a) and 1(b), the lower thin film resistance layer 16C is formed on the printed circuit board (core material) 20 through the lower insulation layer 14, and a pair of lower conductive pads 18D1 and 18D2 is formed on the lower thin film resistance layer 16C separated at a distance L3 so as to oppose each other, resulting in the lower thin film resistance element 10D. On the lower thin film resistance element 10D, an upper insulation layer 14A is formed. In the upper insulation layer 14A, a pair of via holes 19-1 and 19-2 is form to reach the pair of lower conductive pads 18D1 and 18D2. On the upper insulation layer 14A, an upper resistance thin film resistance layer 16E is formed, so that it is electrically connected to the pair of lower conductive pads 18D1 and 18D2 through the pair of via holes 19-1 and 19-2. On the upper thin film resistance layer 16E, there is formed a pair of upper conductive pads 18E1 and 18E2 separated at a distance L4, resulting in the upper thin film resistance element 10E electrically connected to the lower thin film resistance element 10D in parallel.

Here, the resistance length of the lower thin film resistance element 10D is made to be L3 defined by the separated distance between the pair of lower conductive pads 18D1 and 18D2 opposing to each other, and the resistance length of the upper thin resistance element 10E is made to be L4 defined by the separated distance between the pair of upper conductive pads 18E1 and 18E2 opposing to each other.

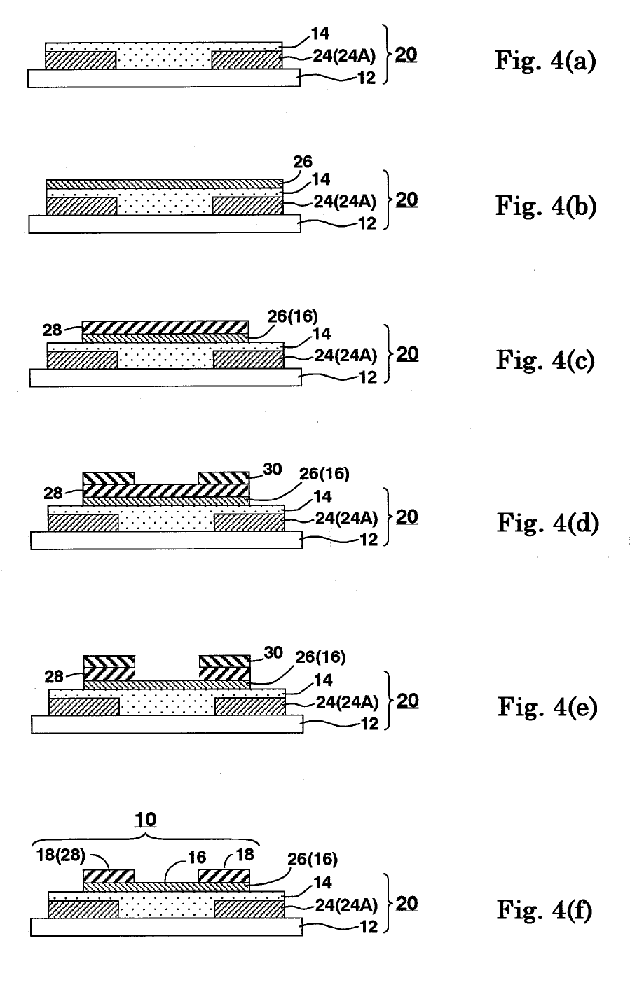

With referring to FIGS. 4(a) to 4(f), a production method of a thin film resistance element according to the present invention is detailed.

FIGS. 4(a) to 4(f) are sectional views for explaining a production method of a thin film resistance element of the present invention.

In FIG. 4(a), a numerical character 20 designates a printed circuit board (core material) comprising a core or substrate 12 made of, for instance, resin, a copper plate 24 being laminated on the core 12 and an insulation layer 14 coated over the core 12 and the copper plate 24. The copper plate 24 has an inner circuit pattern 24A being wet-etched by, for instance, the photolithography method. The inner circuit pattern 24A is surface-treated by a blackening or a wet etching. On the surface of the inner circuit pattern 24A there is formed the insulation layer 14 by a soft-etching method. Then, the insulation layer 14 is surface-treated (roughened or activated) through a dry or wet process.

Next, as shown in FIG. 4(b), on the insulation layer 14, a thin film resistance layer 26 having a predetermined thickness, for instance, of 0.15 μm is deposited by the dry process like as the sputtering method by using a resistive material (for instant, Ni: 99.9%). The thin film resistance layer 26 is formed, for instance, under following conditions.

Type of a gas to be used: Ar, a pressure of the gas: 0.4 Pa (3 mTorr), an output of DC power: 400 W, and a temperature: the room temperature. In this case, it is confirmed that a thickness deviation of the thin film resistance layer 26 is about ±5% to the predetermined thickness of 0.15 μm. This implies that the accuracy of the film thickness by this method is much better than that of the printed resistance body by the printing method using the resistive paste in the prior art, wherein the thickness deviation of the printed resistance body is about ±20%. Further, a deviation of the dimensions in the pattern of the thin film resistance layer 26 is about ±5%.

Next, as shown in FIG. 4(c), a conductive layer 28 made of, for instance, Cu is formed on the thin film resistance layer 26 (16) by an electric plating method. Further, a pattern as an outer layer is formed in the conductive layer 28 by the photolithography method. In particular, in the case of using a resistive material having a high resistivity, prior to forming the conductive layer 28, a thin film layer of Cu may be formed on the thin film resistance layer 26 (16) by the sputtering method to enhance the electrical conductivity between the thin film resistance layer 26 (16) and the conductive layer 28. This thin film layer of Cu enables to form an excellent conductive layer 28 by the electric plating method. In this case, both the conductive layer 28 and the thin film resistance layer 26 (16) are etched to form a pattern therein. For example, for etching both the conductive layer 28 made of Cu and the thin film resistance layer 26 (16) made of Ni at the same time, the solution of cupric chloride is used. Needless to say, they can be etched separately or at the same time according to a desired design.

As shown in FIG. 4(d), as a mask material of a selecting etching, for instance, a photo-resist 30, which is usually used as a protection layer, is coated on the conductive layer 28 by the screen printing method. Then, a pattern for making a thin film resistance element 16 is formed on the photo-resist 30 by exposing and developing the photo-resist 30. It is preferable that the photo-resist 30 has excellent resistance to alkalis to resist the alkali etching solution used in the next step.

Next, as shown in FIG. 4(e), the conductive layer 28 is etched excepting the portion masked with the photo-resist 30. Usually, as an etching solution for Cu, an acid system etching solution may be used. In this embodiment, however, the alkali system etching solution is used to selectively etch out the conductive layer 28 made of Cu, remaining the thin film resistance layer 26 (16) formed under the conductive layer 28. As the etching solution, for instance, A-process solution (Meltex) is available. The etching was performed by a spray method for 60 sec under a temperature of 45° C. As a result, a portion of the conductive layer 28 of Cu without the photo-resist 30 is perfectly etched out, remaining the masked portion, and the thin film resistance layer 16 formed under the conductive layer 28 is exposed.

The surface of the thin film resistance layer 16 exposed is evaluated by using the ESCA (Electron Spectroscopy for Chemical Analysis) (ULVAC Φ). As the result of evaluation, a peak value of Ni and a thickness of the thin film resistance layer 16 made of Ni are no difference between the initial state and the state after being etched.

As shown in FIG. 4(f), the photo-resist 30 of the masking portion is removed from the conductive layer 28 by using a separating solution, resulting in a pair of pads 18 and 18. As the separating solution, Resist Stripper 9296 (Nippon MacDamid Co. Ltd.) is available.

As mentioned above, since the patterning shown in FIGS. 4(d), 4(e) and 4(f) is performed by using the photolithography process, it is possible to obtain the thin film resistance element 10 having the dimensions accuracy of about ±5%, which is better than the dimensions accuracy of about ±10% of the one formed with the resistance paste by the screen printing method in the prior arts.

This fact implies that the production method of the thin film resistance element 10 according to the present invention is an excellent one capable of controlling the dimensions thereof in high accuracy, accordingly capable of reducing a deviation of value of resistivity of the thin film resistance element 10 compared with that in the prior arts.

[Fourth Embodiment]

Generally speaking, a thin film resistance element generates a heat, which raises a temperature of it when a current flows through the thin film resistance element. It is just the same with the thin film resistance element 10 mentioned in FIG. 4(f). The degree of the temperature rise depends on a current density, an electric resistive material and an installed state of the thin film resistance element. For instance, the thin film resistance element formed in an inner layer has a worse heat dissipation characteristic than that of the one formed on an outer layer because the thin film resistance element of the inner layer is sandwiched by lower and upper insulation layers (resin), resulting in a high temperature rise compared with the one formed on the outer layer. Thus, the description is given to a thin film resistance element of a fourth embodiment in the present invention, wherein the heat dissipation of the thin film resistance element is improved.

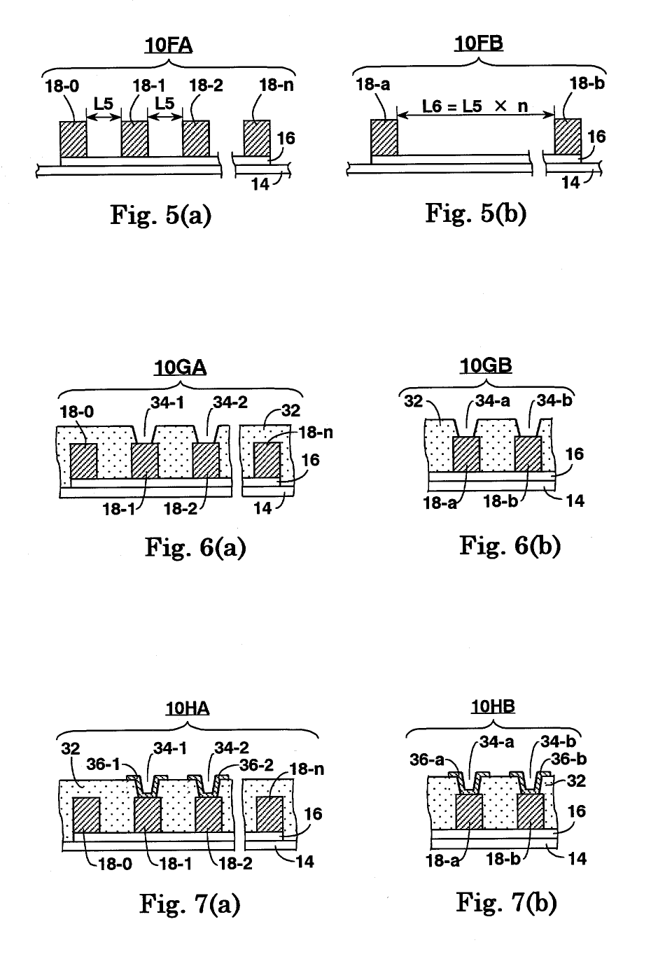

FIGS. 5(a) and 5(b) are sectional views for explaining a thin film resistance element of a fourth embodiment in the present invention.

Referring to FIG. 5(a), in the thin film resistance element 10FA of a fourth embodiment in the present invention, a plurality of small thin film resistance elements are electrically connected in series.

Specifically, on a printed circuit board (core material) having the insulation layer 14 thereon, a thin film resistance layer 16 is formed, and a plurality of conductive pads 18-0 to 18-n are formed on the thin film resistance layer 16, each separated at a distance L5. Thus, a real resistance length of the thin film resistance element 10FA is represented as “L5×n”, wherein a character “n” designates a number of the small thin film resistance elements, each formed between the opposite pads 18-0 to 18-n. Here, the value of “L5×n” is made to be a resistance length of L6.

In FIG. 5(b), there is illustrated a thin film resistance element 10FB having a resistance length of L6 between two conductive pads 18-a and 18-b. When the thin film resistance element 10FA shown in FIG. 5(a) is compared with the thin film resistance element 10FB shown in FIG. 5(b), the thin film resistance element 10FA has a better heat dissipation than that of the thin film resistance element 10FB because a total surface area of the conductive pads 18-0 to 18-n is larger than that of the thin film resistance element 10FB. This fact enables to input a large electric power to the thin film resistance element 10FA compared with the thin film resistance element 10FB.

[Fifth Embodiment]

FIGS. 6(a) and 6(b) are sectional views for explaining a thin film resistance element of a fifth embodiment in the present invention.

Referring to FIGS. 6(a) and 6(b), the thin film resistance elements 10FA and 10FB shown in FIGS. 5(a) and 5(b) are installed in an inner layer made of an insulation layer (resin) 32, respectively. In this case, it is preferable to provide recesses 34-1 and 34-2 or 34-a and 34-b (hereinafter generically referred to as recess 34) such as holes or ditches in the insulation layer 32 to expose top surfaces of the conductive pads 18-1 and 18-2 or 18-a and 18-b, so that thin film resistance element 10GA or 10GB may effectively dissipates the heat generated from themselves.

[Sixth Embodiment]

FIGS. 7(a) and 7(b) are sectional views for explaining a thin film resistance element of a sixth embodiment in the present invention.

As shown in FIGS. 7(a) and 7(b), in thin film resistance elements 10HA and 10HB of a sixth embodiment, the thin film resistance elements 10GA and 10GB shown in FIGS. 6(a) and 6(b) are further provided with thermally conductive layers 36-1 and 36-2 or 36-a and 36-b (hereinafter generically referred to as conductive layer 36) made of, for instance, an electrically conductive material on inner surfaces of the recesses 34 to effectively increase the heat dissipation.

[Seventh Embodiment]

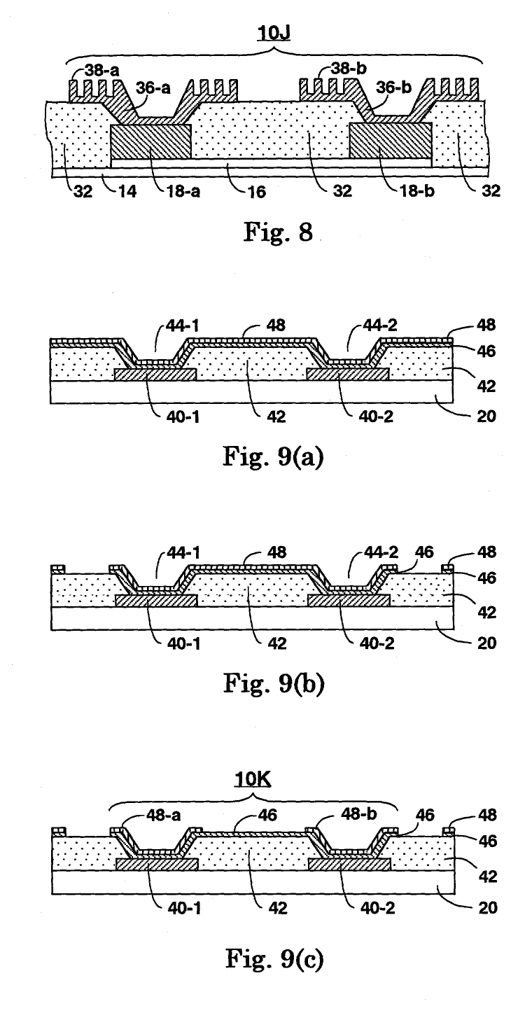

FIG. 8 is a sectional view for explaining a thin film resistance element of a seventh embodiment in the present invention.

As shown in FIG. 8, in a thin film resistance elements 10J of a seventh embodiment, the thin film resistance element 10HB shown in FIG. 7(b) is further provided with fins 38-a and 38-b having a concavity or a convexity on a surface of the conductive layers 36-a and 36-b extending to a flat surface of the insulation layer 32, so that a surface area of the conductive layers 36-a and 36-b is increased. The fins 38-a and 38-b having the concavity or the convexity can be formed on the conductive layers 36-a and 36-b by using the photolithography method, a laser processing or a roughening treatment. Thereby, more effective heat dissipation is expected of the thin film resistance element 10J.

[Eighth Embodiment]

In the production method of the thin film resistance elements referred to FIGS. 4(a) to 4(f), the description is given to the embodiment where the thin film resistance element 10 is formed on the same plane, however, the present invention is not limited to the above embodiment. The production method is applicable to the cases where the thin film resistance element of the present is connected to another circuit pattern formed in the same plane (layer) or a different plane (layer) through a via hole, which has a function for electrically connecting one circuit to another circuit formed in the different layer.

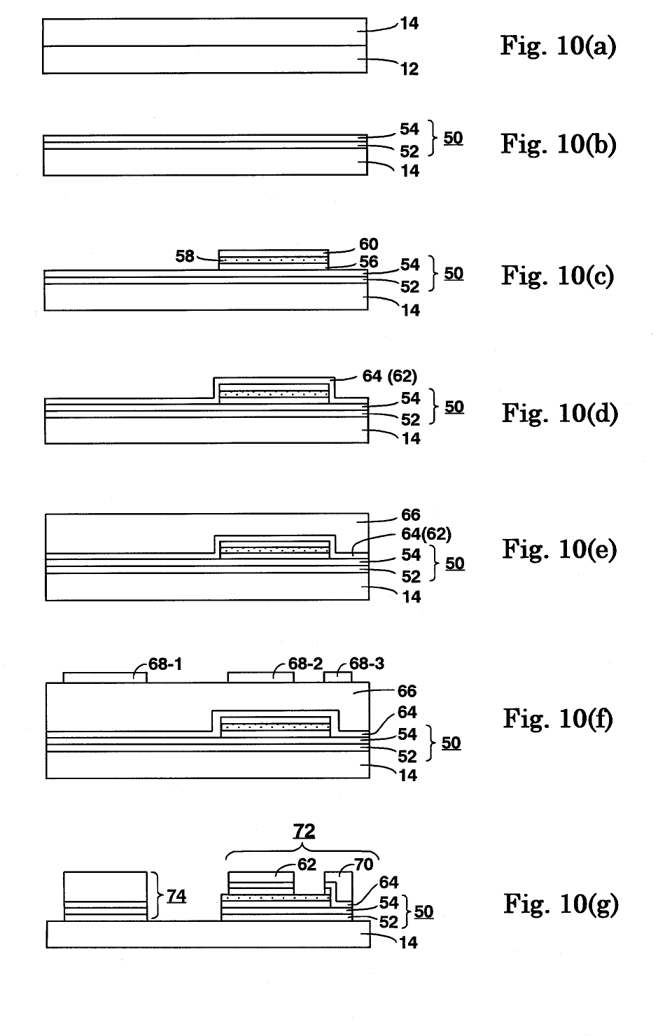

FIGS. 9(a) to 9(c) are sectional views for explaining a production method of a thin film resistance element in a eighth embodiment in the present invention, wherein the thin film resistance element is electrically connected to a circuit pattern formed in an inner layer of a printed circuit board. Referring to FIGS. 9(a) to 9(c), a character 20 designates a printed circuit board (core material) comprising a core or a substrate, a thin copper plate having a circuit pattern and an insulation layer as the same constitution as the printed circuit board of the respective embodiments mentioned above. In FIG. 9(a), inner circuit patterns 40-1 and 40-2 (hereinafter generically referred to as inner circuit pattern 40) are formed on the surface of the printed circuit board and an insulation layer 42 is formed to cover the inner circuit pattern 40. In the insulation layer 42 a pair of via holes 44-1 and 44-2 is formed to expose desired parts of the inner circuit pattern 40. A thin film resistance layer 46 is formed on the insulation layer 42, resulting that the thin film resistance layer 46 is electrically connected to the desired parts of the inner circuit pattern 40 through the pair of via holes 44-1 and 44-2. On the thin film resistance layer 46, there is formed a conductive layer 48, for instance, made of Cu.

As shown in FIG. 9(b), in order to make a thin film resistance element 10K (shown in FIG. 9(c)), a pair of portions stacked with the thin film resistance layer 46 and the conductive layer 48 is removed by the patterning and etching methods, as mentioned in FIG. 4(c) in the foregoing. Next, as shown in FIG. 9(c), a part of the conductive layer 48 of Cu is etched to expose the thin film resistance layer 46, as mentioned in FIGS. 4(e) and 4(f) in the foregoing. Thus, the thin film resistance element 10K connected to the inner circuit pattern 40 can be obtained.

According to this method, it is possible to optionally form the thin film resistance element on the printed circuit board 20 and to electrically connect the thin film resistance element 10K to the inner circuit pattern 40 of the printed circuit board 20 through the via holes 44-1 and 44-2.

[Ninth Embodiment]

In the embodiments mentioned in the foregoing, forming a thin film resistance element is detailed as a passive element. However, such a passive element is not limited to a thin film resistance element. A capacitance element or inductance element can be formed by the production method mentioned in the foregoing as a passive element. A thin film capacitance element formed by the production method mentioned in the foregoing is detailed next.

A thin film capacitance element can be formed on or contained in a printed circuit board by the dry process, which is widely used for producing semiconductors, as the same processes as the production method of a thin film resistance element mentioned in the foregoing. More exactly, a lower electrode layer, a dielectric layer and an upper electrode layer are formed by the dry process such as a sputtering method or formed by the wet process such as plating together with the dry process. The dry process includes a sputtering method, an ion plating method, a vapor deposition method and a CVD method. The feature of the dry process for forming the thin film is to easily control a thickness of the thin film. Thereby, it is possible to obtain a thin film with a desired thickness in high accuracy compared with the screen printing method in the prior arts. Further, it is easy to form a film thinner, so that a high capacitance value can be obtained. Furthermore, in the dry process, a photolithography method is used for forming an electrode pattern in a thin film. The accuracy of the electrode pattern obtained thereby is better than that by the screen printing method. Accordingly, a capacitance low in deviation of capacitance value and high in accuracy can be obtained.

FIGS. 10(a) to 10(g) are sectional views for explaining a production method of a thin film capacitance element of the present invention.

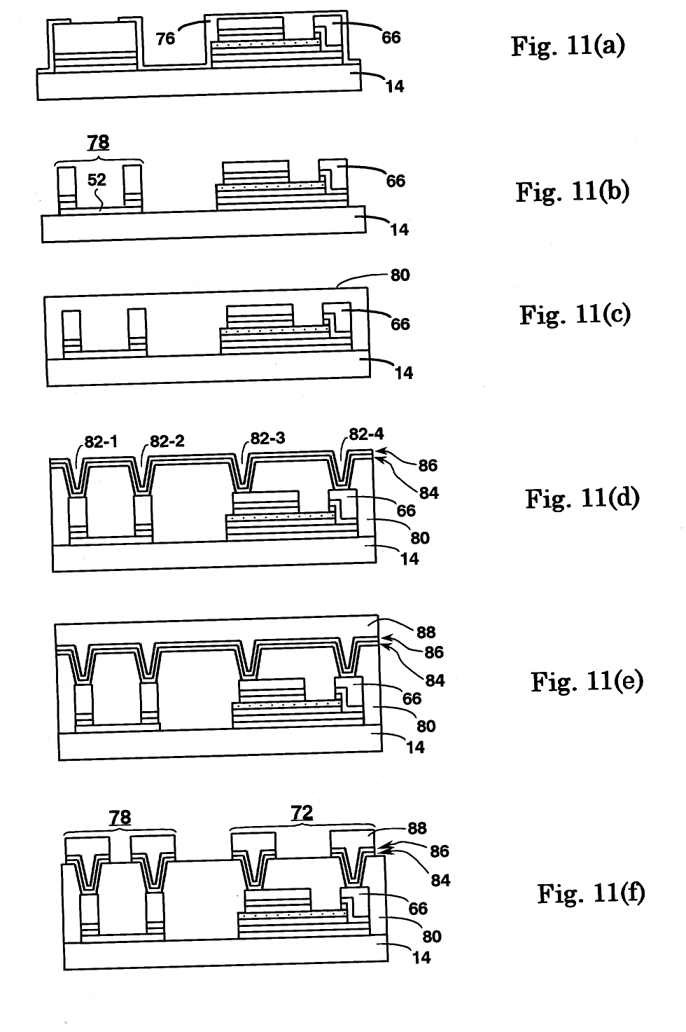

FIGS. 11(a) to 11(f) are sectional views for explaining an additional production method of a thin film resistance element in succession to the processes for forming the thin film capacitance element shown in FIGS. 10(a) to 10(g).

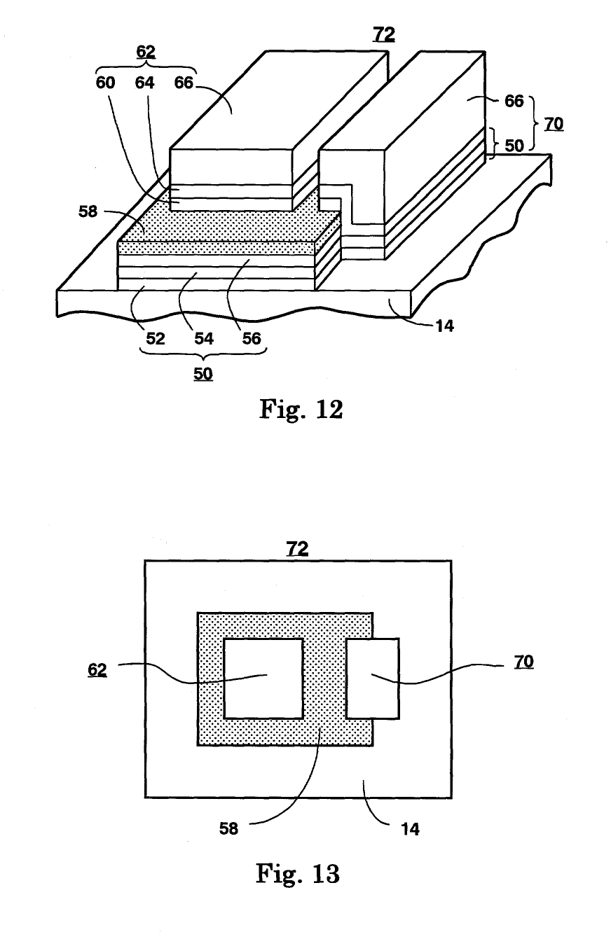

FIG. 12 is a perspective view of the thin film capacitance element shown in FIG. 10(g).

FIG. 13 is a plan view of the thin film capacitance element shown in FIG. 12.

In FIG. 10(a), an insulation layer 14 is formed on a printed circuit board (core or substrate) 12, which is similar to that shown in FIGS. 1(a) and 1(b), by the screen printing method or like. The structure of this stage is identical to that shown in FIGS. 1(a) and 1(b). The printed circuit board 12 is omitted from FIGS. 10(b) to 10(g) and 11(a) to 11(f).

As shown in FIG. 10(b), the surface of insulation layer 14 is surface-treated (roughened or activated) through a dry or wet process such as a reverse sputtering method. In this process, the surface of the insulation layer 14 is not only activated by a molecular level but also roughened in some degree. The surface roughness Ra of the insulation layer 14 is less than 1 μm. Then, a material to be formed as a lower electrode layer 50 is filmed on the insulation layer 14 by the dry process. The lower electrode layer 50 is composed of a contact layer 52 (for instance, NiCr) and a conductive layer 54 (for instance, Cu), wherein the contact layer 52 having a film thickness of 1 μm and the conductive layer 54 having a film thickness of 0.3 μm are formed sequentially by the sputtering method. In addition, the contact layer 52 of NiCr functions as a thin film resistance element. Further details will be depicted later.

Next, as shown in FIG. 10(c), a metal mask (not shown) is set over the conductive layer 54. Then, a lower contact layer 56, a dielectric layer 58 and an upper contact layer 60 are sequentially filmed and laminated by the sputtering method on a predetermined position of the conductive layer 54 necessary to forming a capacitance element. The lower and upper contact layer 56 and 60 are made of NiCr respectively and the film thickness of them is 0.1 μm respectively. The dielectric layer 58 is made of alumina and its film thickness is 0.1 to 1.0 μm. As for a material of these lower and upper contact layers 56 and 60 other than NiCr, such materials as Pt, Ni and Ti are available. Further, other materials of the dielectric layer 58 than alumina are BST, PZT, STO and TiO₂.

As shown in FIG. 10(d), a conductive layer 64 is formed all over the conductive layer 54 and upper contact layer 60 laminated by sputtering a material to be formed as an upper electrode layer 62 after removing the metal mask. A material of the conductive layer 64 is Cu and its film thickness is 0.3 μm.

Next as shown in FIG. 10(e), by applying the electric Cu plating method, a Cu plated layer 66 is formed, wherein the film thickness of the Cu plated layer 66 is 25 μm.

In FIG. 10(f), photo-resist 68-1 to 68-3 are formed on the Cu plated layer 66 by the screen printing method or the electrodeposition method and removed by the patterning method. In this process, the area of the photo-resist 68-2, which corresponds to forming the upper electrode layer 62, is designated to be larger slightly than that of the dielectric layer 58 in the lower layer. The photo-resist 68-3 is provided to form a pad 70 (shown in FIG. 10(g)) for leading out the lower electrode layer 50.

As shown in FIG. 10(g), the pattern etching method is conducted through the photo-resist 68-1 to 68-3 patterned as a mask by an etching solution such as the solution of cupric chloride and the solution of ferric chloride, which is commonly used for producing a printed circuit board. As for the etching solution, such solution that can etch copper and NiCr but can not etch the dielectric layer 58 is used. Then the photo-resist 68-1 to 68-3 is removed. The major point of this process is that the positions of upper and lower electrode layers 62 and 50 are never displaced with respect to each other, because the upper electrode layer 62 and the lower electrode 50 are etched and patterned simultaneously. Consequently, a thin film capacitance element 72, which is composed of the lower electrode layer 50, the dielectric layer 58 and the upper electrode layer 62 can be formed. In this case, the width of lower electrode layer 50 is longer than that of the dielectric layer 58. The tip portion of the lower electrode layer 50, which spreads out from the tip of the dielectric layer 58 to the right, is connected to the pad 70 for leading out the lower electrode layer 50 outside. The top surface of the pad 70 is approximately the same height as the top surface of the upper electrode layer 62.

The perspective view of the thin film capacitance element 72 is shown in FIG. 12 and its the plan view is shown in FIG. 13.

Further, in FIG. 10(g), a land portion 74 for forming a thin film resistance element is formed together with the thin film capacitance element 72. The land portion 74 is composed of a contact layer 52, a dielectric layer 54, dielectric layer 64 and a Cu plated layer 66, which are laminated sequentially.

Accordingly, the thin film capacitance element 72 having a thin dielectric film can be formed on the insulation layer 14.

In addition thereto, in the case of forming a thin film resistance element on the same insulation layer 14 as the thin film capacitance element 72 is formed, it can be realized by adding additional processes mentioned below to the production method mentioned in the foregoing. The land portion 74 shown in FIG. 10(g) is used for forming such a thin film resistance element.

In FIG. 11(a), a photo-resist 76 is formed over the thin film capacitance element 72 and the land portion 74 shown in FIG. 10(g) by the screen printing method or the electrodeposition method and the patterning method for forming a thin film resistance element is applied.

Next, as shown in FIG. 11(b), a thin film resistance element 78 composed of a contact layer 52 of Ni—Cr is formed by selectively etching the Cu film on the land portion 74 with alkaline etching solution (for instance, A-process solution by Meltex) or formic acid system etching solution (for instance, CZ8100 by Mec Company Ltd.). Then, passive elements such as the thin film resistance element 74 formed as mentioned above and the thin film capacitance element 72 are embedded in the printed circuit board.

As shown in FIG. 11(c), an insulation layer 80 is formed over the hole area of the printed circuit board by the screen printing method after the Cu film is conducted by the surface treatment.

Next, as shown in FIG. 11(d), via holes 82-1 to 82-4, which have a function for electrically contacting or connecting one circuit to another circuit, are formed toward the respective electrodes by the laser process and the all surfaces of the via holes 82-1 to 82-4 and the insulation layer 80 are activated by the dry process method such as the reverse sputtering method. Then, a contact layer 84 (for instance, NiCr) and a conductive layer 86 (for instance, Cu) are formed with sequentially laminated on the insulation layer 80. The contact layer 84 having the thickness of 0.1 μm and the conductive layer 86 having the thickness of 0.3 μm are sequentially formed by the sputtering method.

As shown in FIG. 11(e), a Cu plated layer 88 is formed over the whole area of the printed circuit board by the electric copper plating method, wherein the thickness of Cu plated layer 88 is 25 μm.

Next, as shown in FIG. 11(f), the contact layer 84, the conductive layer 86 and the Cu plated layer 88 sequentially laminated over the insulation layer 80 are processed by the patterning method as the same method as mentioned in FIGS. 10(f) and 10(g).

As a result of processes mentioned in the foregoing, the thin film capacitance element 72 and the thin film resistance element 78 can be embedded in the printed circuit board.

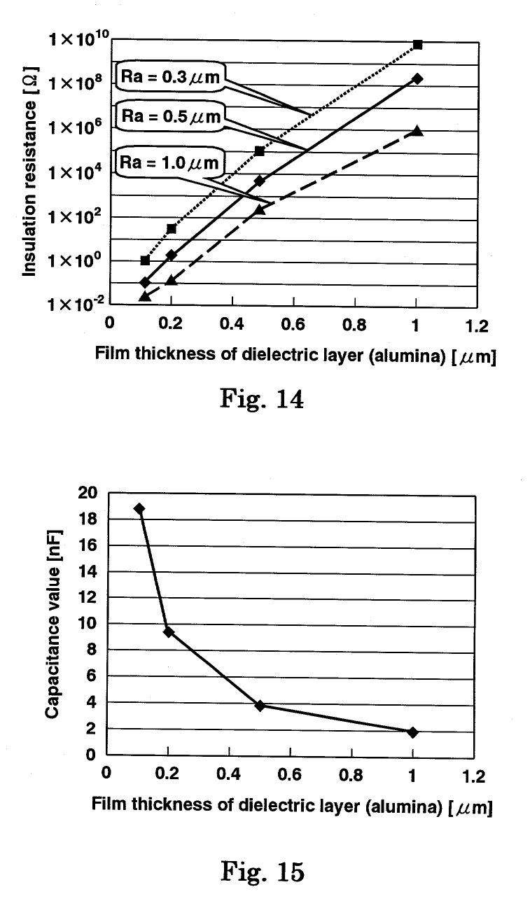

Electric characteristics of the thin film capacitance element 72 formed as mentioned in the foregoing are shown in FIGS. 14 and 15.

FIG. 14 is a graph showing a relation between a thickness of dielectric layer and an insulation resistance value of the thin film capacitance element shown in FIG. 12. In FIG. 14, three lines represent respective surface roughness Ra of the insulation layer 14 as a parameter.

FIG. 15 is a graph showing a relation between a thickness of dielectric layer and a capacitance value of the thin film capacitance element shown in FIG. 12.

As it is apparent from the graphs shown in FIGS. 14 and 15, it is confirmed that insulation resistance of the thin film capacitance element 72 increases and capacitance of the thin film capacitance element 72 decreases in accordance with the increasing of film thickness of alumina or the dielectric layer 58. Thus, designating the area of upper electrode layer 62 and the thickness of dielectric layer 58 can obtain a desired capacitance value.

As mentioned in the foregoing, since a thin film capacitance element can be formed on an insulation layer by the dry process method used for producing a semiconductor, accuracy of a capacitance value of thin film capacitance element can be improved by increasing a dimensional accuracy of pattern of electrode and dielectric body and suppressing the deviation of capacitance value.

Further, a surface of insulation layer as a foundation is activated by the dry process method such as the reverse sputtering method so as to improve adhesion to an upper layer. Therefore, it is advantageous to increase a capacitance value higher due to capable of thinning a film as well as to improve withstanding voltage in comparison with the conventional surface roughening method, which has a problem of causing short circuit frequently.

Furthermore, an upper electrode layer, a lower electrode layer (designating a dielectric layer film as a etching mask) and a pad for leading out lower electrode are simultaneously etched by the pattern etching method, so that a number of processes can be decreased. More, the upper and lower electrodes are never displaced with respect to each other by applying the pattern etching method simultaneously.

Moreover, the upper electrode is formed by the electroplating method, so that a film thickness of the upper electrode layer can be made thicker. Consequently, it is possible to form a via hole right over the thin film capacitance element without providing a pad for leading out the upper electrode layer. In addition, the upper electrode layer and the dielectric layer are free from damage caused by the surface treatment applied prior to forming the insulation layer.

In addition thereto, the top surface of upper electrode layer and the top surface of pad for leading out lower electrode are approximately in the same horizontal level, so that an power of laser light for processing can be set to the same power while forming a via hole. Therefore, troublesome adjustment of laser power is not necessary.

[Tenth Embodiment]

Forming the thin film resistance element and the thin film capacitance element as the passive element is explained in the respective embodiments mentioned in the foregoing. A passive element is not limited to them. An inductance element can be formed.

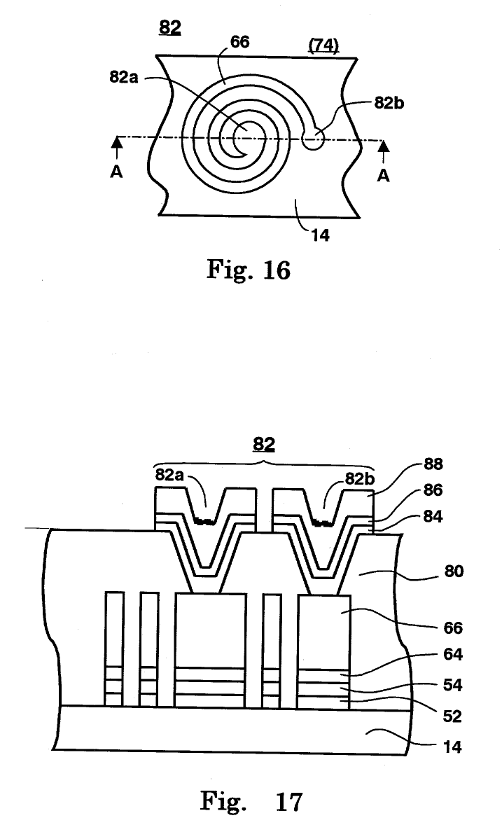

FIG. 16 is a plan view of an inductance element of the present invention.

FIG. 17 is a vertical sectional view of the inductance element taken substantially along line A-A of FIG. 16.

In FIG. 16, an inductance element 82 is formed such that the land portion 74 shown in FIG. 10(g) is etched spirally and both ends 82a and 82b are designated to be electrodes. In FIG. 17, the land portion 74 composed of a contact layer 52, conductive layers 54 and 64 and a Cu plated layer 66 is spirally etched as the same processes as shown in FIGS. 11(a) and 11(b). Then, a contact layer 84, a conductive layer 86 and a Cu plated layer 88 sequentially laminated over an insulation layer 80 are processed by the patterning method as the same processes as mentioned in FIGS. 11(c) to 11(f).

Accordingly, the inductance element 82 having two electrodes 82a and 82b can be formed.

[Eleventh Embodiment]

In the ninth embodiment, the thin film capacitance element 72 is formed by sputtering the dielectric layer 58. However, it can be formed by the other producing method such as the paste printing method.

In this embodiment, a thin film capacitance element formed by the paste printing method is detailed, wherein a thin film capacitance element is formed on one side (upper side) of a printed circuit board and a thin film resistance element is formed on the other side (lower side) of the printed circuit board. However, it is to be understood that such a construction of forming a thin film capacitance element and resistance element on opposite sides of a printed circuit board can be altered to forming them together on the same side of the printed circuit board.

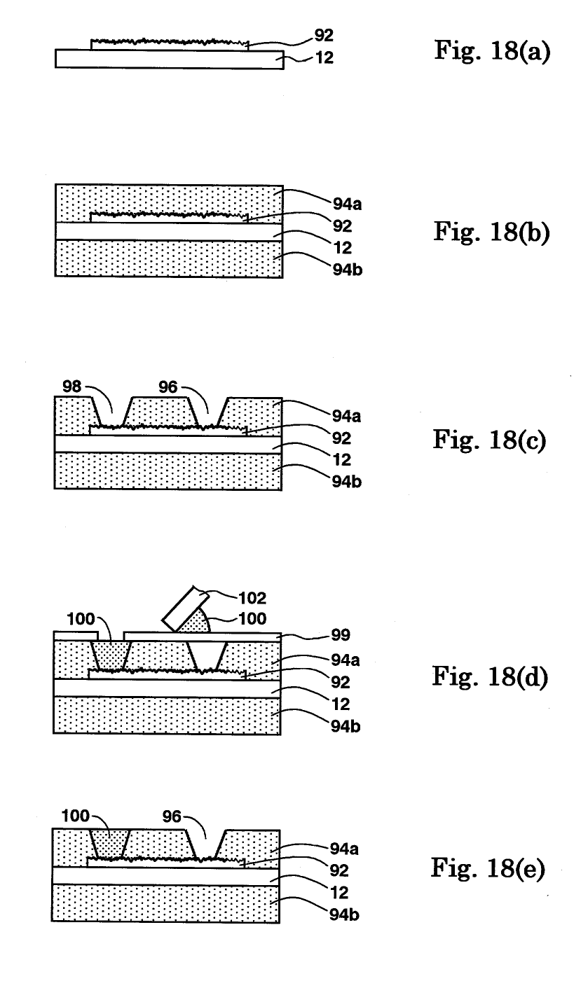

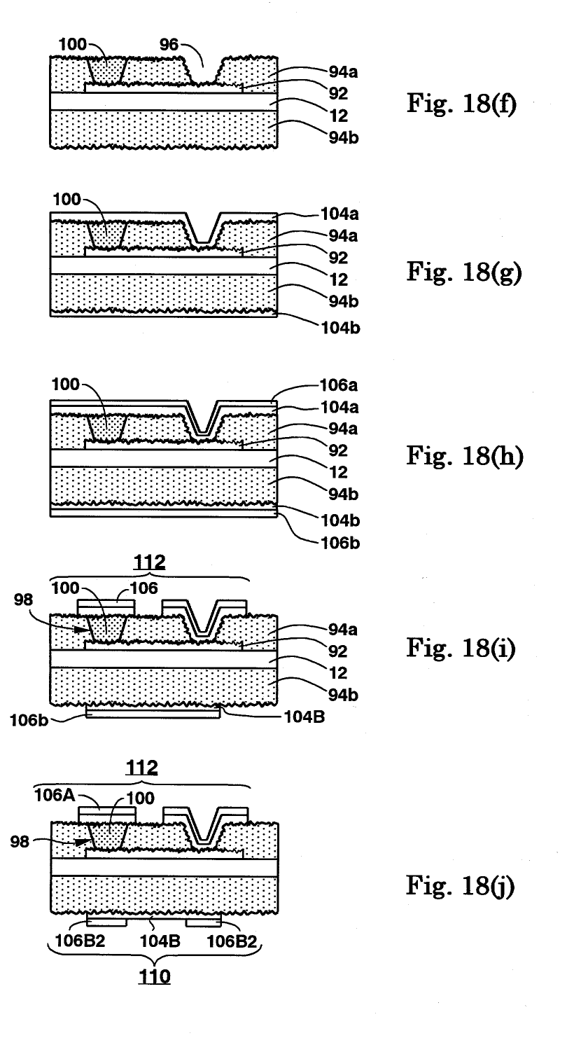

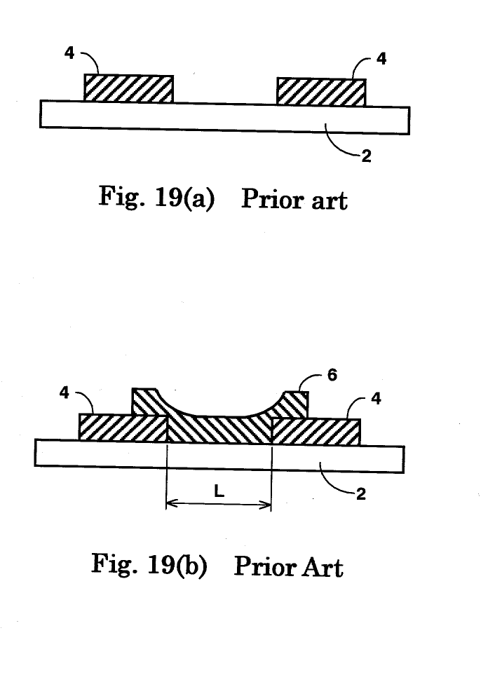

FIGS. 18(a) to 18(j) are sectional views for explaining another production method of a thin film capacitance element of the present invention.

At first, as shown in FIG. 18(a), a conductive layer 92 composed of Cu, for instance, which is formed on the surface of a printed circuit board 12, is formed in a predetermined pattern by the etching method. Further, in order to increase adhesion force of the conductive layer 92, the surface of the conductive layer 92 is processed by the micro etching method with an etching solution such as CZ-8100 by Mec Company Ltd. In FIG. 18(a), a conductive layer on the lower surface is omitted.

As for the conductive layer 92, it is to be understood that a copper film, which is previously formed on the surface of printed circuit board 12, or another copper film, which is formed during a laminating process, can be used.

Next, as shown in FIG. 18(b), upper and lower insulation layers 94a and 94b are formed all over both sides of the printed circuit board 12 by coating organic resin having low permittivity composed of epoxy resin.

As shown in FIG. 18(c), a via hole 96 and a spot facing hole 98 for forming a capacitor are made on the upper insulation layer 94 so as to be connected with an upper layer by using a CO₂ laser or YAG laser, wherein both holes 96 and 98 are shaped in a blind hole not a through hole and allocated in accordance with the conductive layer 92. In this case, when making a hollow having an area equivalent to a capacitor on the insulation layer 94 by a laser beam, it is desirable to make the hollow by a pulse shot with shifting the laser beam at intervals of ½ to 1/1 of a diameter of hole, which can be made by one shot of the laser beam. By this making hollow method, affection of heat accumulated in the upper and lower insulation layers 94a and 94b can be suppressed minimally and an area can be made excellent in accuracy.

In FIG. 18(d), a printing mask 99 is formed all over the upper insulation layer 94a except for the spot facing hole 98 for forming a capacitor. Then, paste 100, which contains filler having high permittivity such as barium titanate, is filled in the spot facing hole 98 by a squeezer 102. In this process, an amount of the paste 100 to be filled is adjusted for such that the height of the paste 100 filled in the spot facing hole 98 becomes the same height as the spot facing hole 98 or slightly lower than that of the spot facing hole 98 after the paste hardened in consideration of printing conditions such as the thickness of printing mask 99. Further, a dispenser can be used in accordance with viscosity of the paste.

Next, as shown in FIG. 18(e), the paste 100 filled in the spot facing hole 98 is hardened after holding the paste 100 to be leveled flat for a while.

As shown in FIG. 18(f), surfaces of both the upper and lower insulation layers 94a and 94b and the paste 100 are activated (micro etched) by the plasma etching method of argon or like. Surface roughness Ra at this moment is approximately within a range of 0.01 to 1 μm, for instance.

Next, in FIG. 18(g), upper and lower contact layers 104a and 104b are formed on both surfaces of the upper and lower insulation layers 94a and 94b with a thin film of nickel or a nickel alloy by the electroless plating method or the sputtering method. The lower contact layers 104b becomes a resistance pattern or a resistance layer, so that its thickness is adjusted in accordance with desired resistance value. For instance, the thickness of contact layer 104b can be adjusted within a range of 0.010 to 2.0 μm in accordance with the desired resistance value.

As shown in FIG. 18(h), upper and lower Cu plated layers 106a and 106b are formed on the upper and lower contact layers 104a and 104b respectively by the electroplating method.

Then, as shown in FIG. 18(i), each pattern of an outer layer connecting pattern, resister and capacitor is formed by using dry a film resist or an ED resist and an etching solution. As for the etching solution, an etching solution such as the solution of cupric chloride, which can dissolve nickel or a nickel alloy, is used. In this case, it is preferable that a dimension of upper electrode layer 106A of paste capacitance element 112 is designated to be larger than the diameter of spot facing hole 98. The larger upper electrode layer 106A can improve adhesion strength between the under layer of the upper electrode layer 106A and the upper insulation layer 94a, and moisture resistance. Further, the lower contact layer 104b is formed so as to be a resistance layer 104B.

Finally as shown in FIG. 18(j), after laminating resistor pattern resist on the lower Cu plated layer 106b, a pair of electrode layers 106B1 and 106B2 and a resistance layer 104B are formed by the etching method by using a selective etching solution, which dissolves copper only but does not dissolve nickel or nickel alloy. In this process, a combination of dry film resist as the resistor pattern resist and formic acid based CZ-8100 (Mec Company Ltd.) as a selective etching solution or another combination of alkali developing type resist as the resistor pattern resist and ammonia based A-process solution (Meltex) as a selective etching solution can be used.

Accordingly, a thin film resistance element 110 on the lower surface and the paste capacitance element 112 can be formed. After the final process, a solder resist for forming a land for soldering, silk printing for marking and auxiliary surface treatment such as gold plating and heat resistance flux can be conducted in accordance with necessity.

In this embodiment, using an effect of providing anchor in sub micron order on the surface of the paste 100 by the plasma etching method and another effect of activating the surface of the paste 100, and further using nickel or nickel alloy, which is stronger in cohesive strength than copper, as the upper and lower contact layer 104a and 104b and plaiting copper on the upper and lower contact layer 104a and 104b results in an electrode having higher contact strength.

Further, while filling the paste 100 having high permittivity, by designating the opening diameter of the printing mask 99 to be smaller than the filling area of the spot facing hole 98, the paste 100 can be prevented from protruding from the opening of the spot facing hole 98. Furthermore, by designating the rise of the paste 100 to be the same height as the thickness of the upper insulation layer 94a or to be slightly lower than that, a grinding process for removing excessive paste can be eliminated. As a result, not grinding can suppress surface roughness of the upper insulation layer 94a.

As mentioned in the foregoing, according to the thin film passive element and the production method thereof, it is possible to exert excellent effects as follows.

According to an aspect of the present invention, there is provided a production method of a thin film capacitance element formed on a printed circuit board (core material). It is possible to form the thin film capacitance element having a thickness and an electrode pattern controlled in a high accuracy thereon. For instance, a film thickness of thin film is easy to be controlled by the dry process, so that a dielectric layer can be formed in a predetermined thickness in high accuracy compared with the screen printing method in the prior arts. Further, it is easy to form a film thinner, so that a high capacitance value can be obtained. Furthermore, the accuracy of the electrode pattern obtained by a photolithography method is better than that by the screen printing method. Accordingly, a capacitance low in deviation of capacitance value and high in accuracy can be obtained. As a result, it is possible to obtain the thin film capacitance element having a capacitance value low in deviation and high in accuracy.

According to another aspect of the present invention, upper and lower electrode and dielectric layers having highly accurate thin film and high accuracy in plain dimensions can be formed. Consequently, deviation of capacitance value can be reduced and the capacitance value can be controlled in high accuracy.

It will be apparent to those skilled in the art that various modification and variations could be made in the thin film resistance element in the present invention without departing from the scope or spirit of the invention.

What is claimed is:

1. A thin film capacitance element formed on a printed circuit board, comprising:
a lower electrode layer formed on the printed circuit board through an insulation layer;
a dielectric layer formed on the lower electrode layer;
an upper electrode layer formed on the dielectric layer; and
an electric pad for leading out the lower electrode layer,
wherein the lower electrode layer is longer than the upper electrode layer in the horizontal direction and connected to the electric pad for leading out the lower electrode layer outside, and wherein the top surface of the upper electrode layer -and the top surface of the electric pad for leading out the lower electrode layer are formed substantially in the same height.

2. The thin film capacitance element as claimed in claim 1, wherein the insulation layer on the printed circuit board is formed with a thin film resistance element thereon and the thin film capacitance element is formed on the same side of the printed circuit board formed with the thin film resistance element.

3. A production method of a thin film capacitance element formed on a printed circuit board, comprising the steps of:
forming a lower electrode layer on the printed circuit board through an insulation layer by a dry process used in producing a semiconductor;
forming a dielectric layer on the lower electrode layer by the dry process; and
forming an upper electrode layer on the dielectric layer by the dry process.

4. The production method of a thin film capacitance element as claimed in claim 3 further comprising a step of forming an electric pad for leading out the lower electrode layer being connected to the lower electrode layer, wherein the lower electrode layer is longer than the upper electrode layer in the horizontal direction.

5. The production method of a thin film capacitance element as claimed in claim 4, wherein the electric pad for leading out the lower electrode layer and the thin film capacitance element are formed simultaneously through one time of a pattern etching process.

6. The production method of a thin film capacitance element as claimed in claim 5, wherein an etching solution used for the pattern etching process can etch the upper and lower electrode layers but hardly etch the dielectric layer.

7. An inductance element formed on a printed circuit board, comprising:
an inductance body formed spirally on the printed circuit board through an insulation layer, wherein the spiral inductance body includes at least a part of a conductive layer spirally; and
a pair of input and output terminals provided on both ends of the inductance body.

8. A production method of an inductance element, comprising the steps of:
forming an inductance body including at least a part of a conductive layer spirally on a printed circuit board through an insulation layer by a dry process used in producing a semiconductor; and
forming a pair of input and output terminals provided on both ends of the inductance body.
